(19) United States
(12) Patent Application Publication
(10) Pub. No.: US 2024/0281657 A1
(43) Pub. Date: Aug. 22, 2024

(54) FRAMEWORK FOR CAUSAL LEARNING OF NEURAL NETWORKS

(71) Applicant: CCNets, Inc., El Dorado Hills, CA (US)

(72) Inventor: Jun Ho Park, Gyeonggi-do (KR)

(21) Appl. No.: 18/638,513

(22) Filed: Apr. 17, 2024

Related U.S. Application Data
(63) Continuation-in-part of application No. 18/222,379, filed on Jul. 14, 2023.
Application No. 18/222,379 is a continuation of application No. PCT/KR2022/004553, filed on Mar. 30, 2022.

(30) Foreign Application Priority Data
Mar. 30, 2021 (KR) 10-2021-0041435
Nov. 25, 2021 (KR) 10-2021-0164081

(51) Int. Cl. G06N 3/08; G06N 3/0475

(52) U.S. Cl. CPC G06N 3/08; G06N 3/0475

(57) ABSTRACT

Disclosed herein is the framework of causal cooperative networks that discovers the causal relationship between observational data in a dataset and a label of the observation thereof and trains each model with inference of a causal explanation, reasoning, and production. In the case of the supervised learning, neural networks are adjusted through the prediction of the label for observation inputs. On the other hand, a causal cooperative network that includes the explainer, a reasoner, and a producer neural network models, receives an observation and a label as a pair, results multiple outputs, and calculates a set of losses of inference, generation, and reconstruction from the input and the outputs. The explainer, the reasoner, and the producer are adjusted by error propagation for each model obtained from the set of losses.

### CROSS-REFERENCE TO RELATED APPLICATIONS

This application is a continuation-in-part of U.S. non-provisional patent application Ser. No. 18/222,379 filed on Jul. 14, 2023 which is a continuation-in-part of International Application No. PCT/KR2022/004553 filed on Mar. 30, 2022 which claims priority to KR 10-2021-0041435 filed on Mar. 30, 2021 and also claims priority to KR 10-2021-0164081 filed on Nov. 25, 2021, the disclosures of the aforementioned applications are incorporated by reference herein.

### BACKGROUND OF THE INVENTION

### Field of the Invention

The present disclosure is an introduction for a new framework for causal learning of neural networks. Specifically, this framework to be introduced in the present disclosure can be understood based on the background theories and technology related to Judea Pearl's ladder of causation, causal models, neural networks, supervised learning, machine learning frameworks, etc.

### Description of the Prior Art

Machine learning allows neural networks to deal with sophisticated and detailed tasks while solving nonlinear problems. Recently, research has been conducted to figure out new frameworks in machine learning to empower neural networks to be capable of adaptation, diversification, and intelligence. Technologies adopting the new frameworks are also rapidly developing.

Various studies are underway to train causal inferences in neural networks for the causal modeling of difficult nonlinear problems. Although the development of a universal framework for causal learning is progressing in this way, it has not achieved much success compared to major frameworks of machine learning such as supervised learning.

Causal learning of the neural network known up until now is generally not easy to use in practice because of its long training time and its analysis being difficult to understand. Therefore, there is a need for a universal framework that can discover causal relationships in domains for various problems and perform causal inferences based on the discovered causal relationships.

Prior Art Literature: (Non-patent Document 1) Stanford Philosophy Encyclopedia—Causal Model (https://plato.stanford.edu/entries/causal-models/)

### SUMMARY

A universal framework that can discover causal relationships in domains for various problems and perform causal inferences based on the discovered causal relationships is provided herein. These methods for causal learning of neural networks provide the following improvements and benefits over the methods of causal learning of the prior art.

A Causal Cooperative Network (CCN) as provided herein is configured to facilitate bidirectional inference capabilities. This functionality enables the system not only to predict outcomes from inputs but also to reconstruct potential inputs from given outcomes. Such dual-directional processing is essential for applications where understanding causal relationships from both perspectives adds significant value, such as in medical diagnostic systems or financial forecasting models. For instance, within a healthcare context, the CCN can diagnose a condition based on symptoms and conversely, suggest possible symptoms for a diagnosed condition, enhancing both diagnostic accuracy and educational utility. Thus, a cooperative network can receive an observation in a source domain and a label for the observation in a target domain, and learn a causal relationship between the source domain and the target domain through the models of an explainer, a reasoner, and a producer.

In contrast to conventional supervised learning models that directly map inputs to outputs, the CCN adopts a more nuanced, multi-stage inferential process involving the use of models of explanation, reasoning, and production. Thus, a cooperative network can receive an observation in a source domain and a label for the observation in a target domain, and learn a causal relationship between the source domain and the target domain through the explainer, reasoner, and producer models. This structured approach not only diversifies the learning pathways but also stabilizes them, making the resulting models more robust against overfitting and enhancing their ability to generalize from relatively sparse data. This method mirrors complex human decision-making processes and is particularly effective in scenarios where direct inference is too rigid or simplistic to capture underlying dynamics.

The CCN is adept at learning a latent space that encapsulates detailed explanations of the data, aligning more closely with real-world distributions instead of conventional normal distributions typical of Variational Autoencoders (VAEs) or edge distributions like those seen in Generative Adversarial Networks (GANs). This achievement in model design, focusing on deterministic features critical to outcomes, ensures that the latent representations—referred to as the explanatory space in the specification—not only retains essential information but also reflects genuine distributions. Such fidelity in the explanatory space enhances the model's predictive reliability and facilitates superior model transferability across diverse datasets.

The CCN possesses the capability to reconstruct the original input data from reasoned outputs utilizing the same explanatory vectors that were employed in the reasoning process, enabling rigorous integrity checks. This feature is highly beneficial in fields requiring high levels of reliability and transparency, such as legal compliance or financial auditing, where decisions must be thoroughly justified and verified. For instance, after determining a loan approval, the network endeavors to regenerate the applicant's profile from the decision itself. A close alignment between the original and reconstructed data validates that the decision was grounded in logical and sound reasoning, thus serving as an effective tool for audit trails and regulatory compliance.

Contrary to stochastic generative models, the CCN employs explanations derived directly from real data or extracted from a learned explanation space, enabling the precise and controlled generation of outputs. Such capability is particularly advantageous in sectors like manufacturing or product design, where exact control over product attributes is paramount. The network utilizes these explanation vectors to ensure that each generated output strictly conforms to the real-world principles and specific characteristics encapsulated in the explanations, making it indispensable in industries where outputs are required to meet stringent standards and specifications.

The CCN is engineered to focus on causal learning, which allows it to potentially construct causal graphs that depict the interdependencies among various factors. This functionality is pivotal in reducing human bias and fostering more objective insights into data relationships, offering significant benefits in disciplines such as social sciences, economics, and healthcare. By adeptly predicting the impact of changes in one variable on another under controlled conditions—and failing to do so when the relationship is non-causal—the network can confirm or disprove theoretical causal connections. This feature is particularly valuable for disciplines that rely on a deep understanding of complex systems and for answering “what-if” questions that require clear causal inferences.

The CCN integrates elements from supervised learning, generative learning, and autoencoders into a unified and comprehensive framework capable of addressing a diverse array of machine learning challenges. By dividing the network into distinct modules dedicated to explaining, reasoning, and producing—each specializing in a different facet of the learning process—the CCN offers a structured, controllable, and transparent approach to machine learning. This segmentation allows for precise adjustments based on deterministic error calculations, enhancing the overall effectiveness and application of the network across various machine learning tasks. This holistic strategy could potentially establish a new benchmark for the development of versatile and robust machine learning systems.

To provide a method of discovering causal relationship between a source domain and a target domain and training a neural network with causal inference.

To provide a method of objectively explaining the attributes of observational data based on causal discovery from statistics.

To provide a neural network training framework for causal modeling that predicts causal effects that change under the control of independent variables.

Objectives to be achieved in the present disclosure are not limited to those mentioned above, and other objectives of the present disclosure will become apparent to those of ordinary skill in the art from the embodiments of the present disclosure described below.

To achieve these objectives and other advantages and in accordance with the purpose of the present disclosure, provided herein is a framework for causal learning of a neural network. It includes a cooperative network configured to receive an observation in a source domain and a label for the observation in a target domain, which learns a causal relationship between the source domain and the target domain. They are learned through models of an “explainer 620”, a “reasoner 630”, and a “producer 640”, each including a neural network. The explainer 620 extracts an explanation vector 625 from an input observation 605, that is representing an explanation of the observation 605 and transmits the vector to the reasoner 630 and the producer 640. The reasoner 630 infers a label from the input observation 605 and the received explanation vector 625 and transmits the inferred label 635 to the producer 640. The producer 640 outputs an observation 655 reconstructed from the received inferred label 635 and the explanation vector 625, and outputs an observation 645 generated from an input label 615 and the explanation vector 625. The errors are obtained from an inference loss 637, a generation loss 647 and a reconstruction loss 657 calculated by the input observation, the generated observation, and reconstructed observation.

According to one embodiment of the present disclosure:

The inference loss 637 is a loss from the reconstructed observation 655 to the generated observation 645, the generation loss 647 is a loss from the generated observation 645 to the input observation 605 and the reconstruction loss 657 is a loss from the reconstructed observation 655 to the input observation 605.

According to one embodiment of the present disclosure:

The inference loss includes an explainer error and/or a reasoner error, the generation loss includes an explainer error and/or a producer error, and the reconstruction loss includes a reasoner error and/or a producer error.

According to one embodiment of the present disclosure:

The explainer error is obtained based on a difference of the reconstruction loss from the sum of the inference loss and the generation loss, the reasoner error is obtained based on a difference of the generation loss from the sum of the reconstruction loss and the inference loss, and the producer error is obtained based on a difference of the inference loss to from the sum of the generation loss and the reconstruction loss.

According to one embodiment of the present disclosure:

Gradients of the error functions with respect to the model parameters are calculated through backpropagation of the explainer error, reasoner error, and producer error.

According to one embodiment of the present disclosure:

The parameters of the models are adjusted based on the calculated gradients.

According to one embodiment of the present disclosure:

The backpropagation of the explainer error calculates gradients of the error function with respect to the parameters of the explainer without being involved in adjusting the reasoner or the producer, the backpropagation of the reasoner error calculates gradients of the error function with respect to the parameters of the reasoner without being involved in adjusting the producer, and the backpropagation of the producer error calculates gradients of the error function with respect to the parameters of the producer.

According to one embodiment of the present disclosure:

The cooperative network includes a pretrained model that is either pretrained or being trained. The input space and output space of the pretrained model are statistically mapped to each other, wherein the neural network models are trained with causal inference by discovering a causal relationship between the input space and the output space of the pretrained model. The pretrained model comprises of an inference model configured to receive the observation 605 as input and maps an output to the input label 615.

According to one embodiment of the present disclosure:

The cooperative network includes a pretrained model that is either pretrained or being trained. The input space and output space of the pretrained model are statistically mapped to each other, wherein the neural network models are trained with causal inference by discovering a causal relationship between the input space and the output space of the pretrained model. The pretrained model comprises of a generative model configured to receive the label 615 and a latent vector as input and maps an output to the input observation 605.

In accordance with another aspect of the present disclosure, provided is a framework for causal learning of a neural network with a cooperative network configured to receive an observation in a source domain and a label for the observation in a target domain. It learns a causal relationship between the source domain and the target domain through models of an explainer 1120, a reasoner 1130, and a producer 1140. Each including a neural network, wherein the explainer 1120 extracts an explanation vector 1125 from an input observation 1105 that represents an explanation of the observation 1105 for a label. The generated observation is transmitted to the reasoner 1130 and the producer 1140. The producer 1140 outputs an observation 1145 generated from a label input 1115 and the explanation vector 1125, and transmits the vector to the reasoner 1130. The reasoner 1130 outputs a label 1155 reconstructed from the generated observation 1145 and the explanation vector 1125, and infers a label from the input observation 1105 and the explanation vector 1125 to output the inferred label 1135. The errors or models are obtained from an inference loss 1137, a generation loss 1147 and a reconstruction loss 1157 calculated by the input label 1115, the inferred label 1135, and the reconstructed label 1155.

According to one embodiment of the present disclosure:

The inference loss 1137 is a loss from the inferred label 1135 to the label input 1115, the generation loss 1147 is a loss from the reconstructed label 1155 to the inferred label 1135, and the reconstruction loss 1157 is a loss from the reconstructed label 1155 to the label input 1115.

According to one embodiment of the present disclosure:

The inference loss includes an explainer error and a reasoner error, the generation loss includes an explainer error and a producer error, and the reconstruction loss includes a reasoner error and a producer error.

According to one embodiment of the present disclosure:

The explainer error is obtained based on a difference of the reconstruction loss from the sum of the inference loss and the generation loss, the reasoner error is obtained based on a difference of the generation loss from the sum of the reconstruction loss and the inference loss, and the producer error is obtained based on a difference of the inference loss from the sum of the generation loss and the reconstruction loss.

According to one embodiment of the present disclosure:

Gradients of the error functions for parameters of the models are calculated through the backpropagation of the explainer error, reasoner error, and producer error.

According to one embodiment of the present disclosure:

The parameters of the neural networks are adjusted based on the calculated gradients.

According to one embodiment of the present disclosure:

The backpropagation of the explainer error calculates gradients of the error function with respect to the parameters of the explainer without being involved in adjusting the reasoner or the producer, the backpropagation of the producer error calculates gradients of the error function with respect to the parameters of the producer without being involved in adjusting the reasoner, and the backpropagation of the reasoner error calculates gradients of the error function with respect to the parameter of the reasoner.

According to one embodiment of the present disclosure:

The cooperative network includes a pretrained model that is either pretrained or being trained. The pretrained model having an input space and an output space that are statistically mapped to each other, wherein the neural network models are trained with causal inference by discovering a causal relationship between the input space and the output space of the pretrained model. The pretrained model comprises of an inference model configured to receive the observation 1105 as input and map an output to the input label 1115.

According to one embodiment of the present disclosure:

The cooperative network includes a pretrained model that is either pretrained or being trained. The pretrained model has an input space and an output space statistically mapped to each other, wherein the neural network models are trained with causal inference by discovering a causal relationship between the input space and the output space of the pretrained model. The pretrained model comprises of a generation model configured to receive the label 1115 and a latent vector as input, and maps an output to the input observation 1105.

### Advantageous Effects

According to the embodiments of the present disclosure, the following effects may be expected.

First, an explanatory model of a neural network that predicts implicit and deterministic attributes of observational data in a data domain may be trained.

Second, a reasoning model of a neural network that infers predicted values with an explanation from observations may be trained.

Third, a production model of a neural network that generates causal effects that changes under control/manipulation according to a given explanation may be trained.

Effects that can be obtained are not limited to the effects mentioned above, and other effects not mentioned will be clearly derived and understood by those of ordinary skill in the art from the embodiments of the present disclosure made known below. In other words, those of ordinary skill in the art will be able to clearly understand the unintended effects that can be achieved by practicing the present disclosure from the following detailed description.

Furthermore, in the description below, an observation, label, source, target, inference, generation, reconstruction, or explanation may refer to a data type such as a point, image, value, vector, code, representation, and vector/representation in n-dimensional/latent space.

### BRIEF DESCRIPTION OF DRAWINGS

Conceptual diagrams are illustrated as follows:

FIG. 1—Illustrates a causal relationship derived from data of the present disclosure.

FIG. 2—Illustrates machine learning frameworks based on statistics in the present disclosure.

FIG. 3—Illustrates a relationship between observations and labels in the present disclosure.

FIG. 4—Illustrates introducing a framework of causal cooperative networks of the present disclosure.

FIG. 5—Illustrates a conceptual diagram illustrating a prediction/inference mode of a cooperative networks of the present disclosure.

FIG. 6—Illustrates a training mode A of the cooperative network of the present disclosure.

FIG. 7—Illustrates an inference loss (in training mode A) of the present disclosure.

FIG. 8—Illustrates a generation loss (in training mode A) of the present disclosure.

FIG. 9—Illustrates a reconstruction loss (in training mode A) of the present disclosure.

FIG. 10—Illustrates backpropagation (in training mode A) of a model error according to the present disclosure.

FIG. 11—Illustrates training mode B of the cooperative network of the present disclosure.

FIG. 12—Illustrates inference loss (in training mode B) of the present disclosure.

FIG. 13—Illustrates a generation loss (in training mode B) of the present disclosure.

FIG. 14—Illustrates a reconstruction loss (in training mode B) of the present disclosure.

FIG. 15—Illustrates backpropagation (in training mode B) of a model error according to the present disclosure.

FIG. 16—Illustrates training (in training mode A) of a cooperative network using an inference model of the present disclosure.

FIG. 17—Illustrates training (in training mode A) of a cooperative network using a generation model of the present disclosure.

FIG. 18—Illustrates a first embodiment to which the present disclosure is applied.

FIG. 19—Illustrates a second embodiment to which the present disclosure is applied.

### DETAILED DESCRIPTION

Throughout this specification, when a part “includes” or “comprises” a component, the part may further include other components, and such other components are not excluded unless there is a particular description contrary thereto. Terms such as “unit,” “module,” and the like refer to units for processing at least one function or operation, which may be implemented by hardware, software, or a combination thereof. Also, throughout the specification, stating that a component is “connected” to another component may include not only a physical connection but also an electrical connection. Further, it may mean that the components are logically connected.

Specific terms used in the embodiments of the present disclosure are intended to provide understanding. The use of these specific terms may be changed to other forms without departing from the scope of the present disclosure.

In the present disclosure, the causal model, neural network, supervised learning, and machine learning framework may be implemented by a controller included in a server or terminal. The controller may include a reasoner module, a producer module, and an explainer module (hereinafter referred to as a “reasoner,” a “producer,” and an “explainer”) according to functions. The role, function, effect etc., and the like of each module will be described in detail below with reference to the drawings.

### 1. Causal Relationship Derived From Data

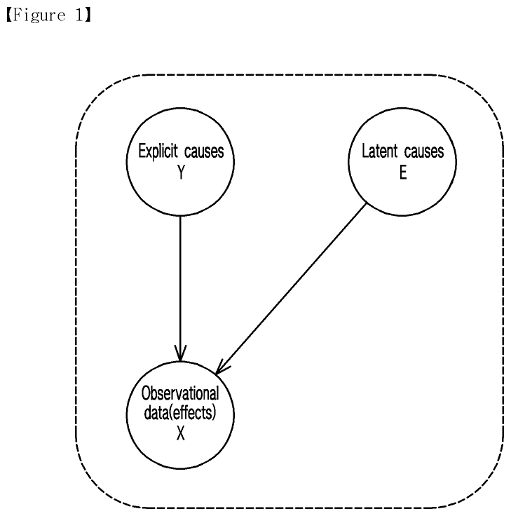

FIG. 1 shows the causal relationship between data results and explicit causes of the results thereof in statistics of any/certain field of studies. Observational data X (or observations, effects), explicit causes Y (or labels), and latent causes E (or causal explanations) are plotted as a directed graph (probabilistic graphical model or causal graph).

The relationship between the observed effects X and explicit causes Y may be found in the independent variable X and the dependent variable Y of the regression problem in machine learning (ML). The mapping task in ML from observation domain X to label domain Y may also be understood in relation to the causal relationship. When it comes to a structure of causal relationships in ordinary events that happen commonly in daily life, it could be expressed that an explicit cause Y has generated an effect X or the cause Y thereof may be inferred from the effect X.

For example, in an event of a gas stove catching fire inside a house, the action of using the gas stove may correspond to the explicit cause Y in the event, and the resulting fire may correspond to the observed effect X.

When the effect X and cause Y of an event contains a causal explanation E, the cause Y may be reasoned from the effect X of the event in the given explanation E. Diversely the effect X may be produced from the cause Y of the event in the given explanation E.

For example, the causal explanation E may represent an explanation describing the event of the fire occurring due to the use of the gas stove, or another latent cause for a fire to occur. The effect X of any event may be produced by an explicit or labeled cause Y and an implicit or latent cause E.

A widely used conventional machine learning framework is based on a statistical approach and its approach may train neural networks to infer a labeled cause Y from an observational data X or generate observational data X from a labeled cause Y based on the relationship between X, and Y through a stochastic process. Causal learning proposed in the present disclosure includes a method of training neural networks to perform causal inferences based on the relationship between X, Y, and E through a deterministic process.

### 2. Machine Learning Framework Based on Statistics

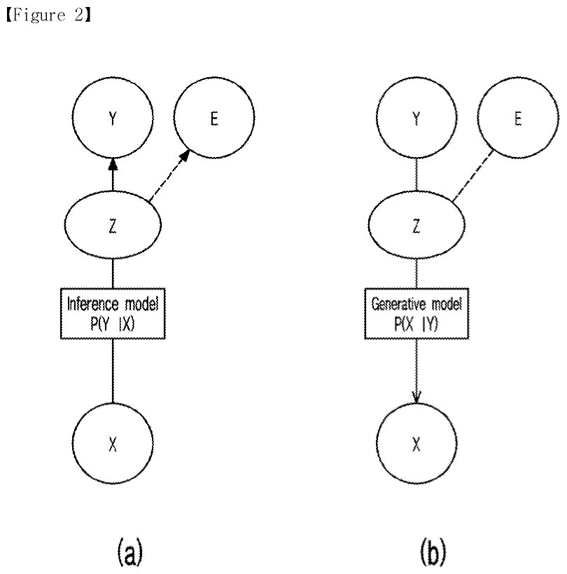

In FIG. 2, the principle of machine learning frameworks based on statistics is causally reinterpreted. The ML framework may refer to modeling of neural networks for data inference or generation by statistically mapping an input space to an output space. The trained models output data points via the ML framework in the output space corresponding to the input in the input space.

In the example of FIG. 2A, the input observation space X is mapped to an output label space Y through an inference (or discriminative) model. For the input of observational data (x) in the observation space X, the model outputs a label (y) in the label space Y. The data distribution through the inference model can be described as a conditional probability distribution P(Y|X). By interpreting through causality, the observational data (x) in the observation space X may correspond to observational effects, and the label (y) in the label space Y may correspond to an explicit cause of the effects.

In the example of FIG. 2B, a conditional space Y and a latent space Z are mapped to an observation space X via the generative model (conditional generative model). For the input of (y) in the conditional space Y and (z) in the latent space Z, observational data (x) in the observation space X is sampled (or generated). The data distribution through the generative model can be represented as a conditional probability distribution P(X|Y). By interpretation through causality, the condition (y) in the conditional space Y may correspond to an explicit cause (or a label); the observational data (x) in the observation space X may correspond to an effect thereof; and (z) in the latent space Z may correspond to a latent representation of the effect.

### 3. Relationship Between Observations and Labels

Suppose that an image xi,k of person (i) (observation point) in an image dataset X(observation space) is generated by yk of the pose (k) (explicit cause) and the identity ei(latent cause) of the person. The person (i)'s image of xi,k is labeled with the pose yk(pose (k)). Also, a person (i+1)'s image of xi+1,k+1 is labeled with a pose yk+1 (pose (k+1)).

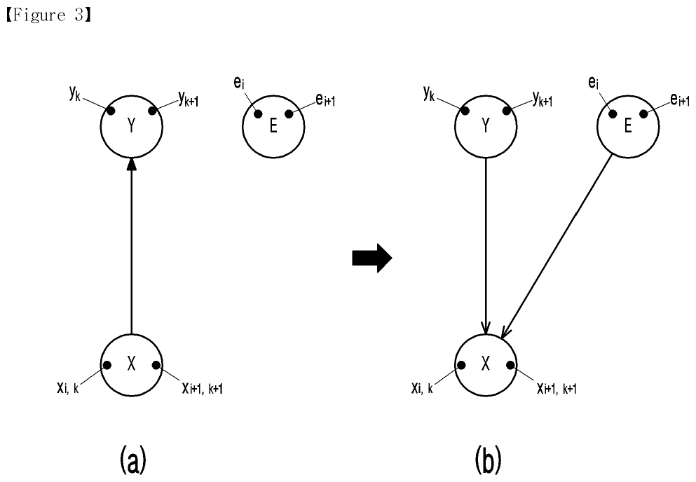

In FIG. 3A, xi, k (person (i)'s image with pose (k)) in the observation space X may be mapped to yk (pose (k)) in the corresponding label space Y. Also, xi+1, k+1 (the person's image (i+1) with the pose (k+1)) in X may be mapped to yk+1 (pose (k+1)) in Y. However, the reverse, yk to xi,k or yk+1 to xi+1,k+1 may not be established. Points in Y cannot be mapped to X because yk or yk+1 does not contain information about the identity.

FIG. 3B illustrates an opposite case, i.e., mapping from the label space Y to the observation space X via the explanatory space E is shown. A point in Y is mapped to a point in X via E. For example, point yk (pose (k)) in Y is mapped to xi,k (the person (i)'s image with the pose (k)) in X via point ei (person (i)'s identity) in E. yk+1 (pose (k+1)) is mapped to xi+1,k+1 (person (i+1)'s image with position (k+1)) via ei+1 (person (i+1)'s identity).

In addition, the observation space X may be mapped to the label space Y via the explanatory space E. A point in X is mapped to a point in Y via E. For example, xi,k (person (i)'s image with the pose (k)) in X may be mapped to point yk (pose (k)) in Y via point ei (person (i)'s identity) in E. xi+1,k+1 (the person (i+1)'s image with the pose (k+1)) may be mapped to yk+1 (pose (k+1)) via ei+1 (i+1-th person's identity).

Through the causal explanation (the person's identity), an explicit cause (a person's pose) may be inferred from the observational data (the person's image). Observational data (a person's image) may be generated from the explicit cause (the person's pose). That is, through the explanatory space E, X can be mapped to Y and Y can be mapped to X. The explanatory space E allows neural networks to perform bidirectional inference (or generation) between the observation space X and the label space Y.

### 4. Causal Cooperative Networks

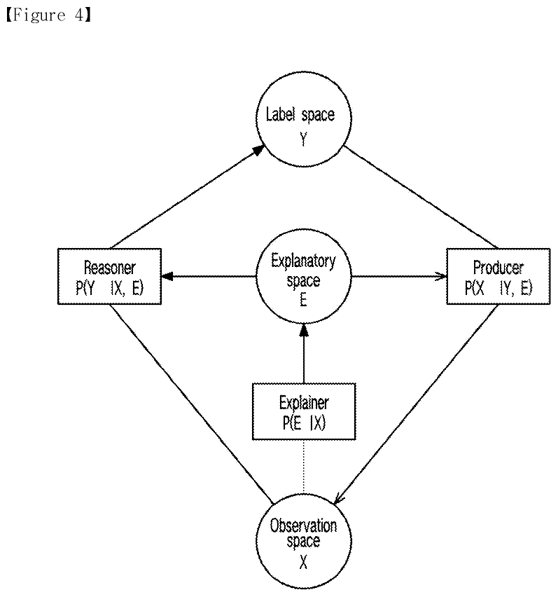

In FIG. 4, a network composed of Explainer, Reasoner and Producer Neural Networks receives an observation in a source domain and a label for the observation in a target domain thereof as an input pair and results in multiple outputs. This calculates a set of inference, generation, and reconstruction losses from the relationship of the input pair and the outputs. The errors are obtained from the loss set through the error function and they traverse backwards through the propagation path of the losses backward to compute the gradients of the error function for each model. A new framework discovering a causal relationship between the source and the target domain, learning the explanatory space of the two domains, and performing causal inference of the explanation, reasoning and effects-Causal Cooperative Networks (hereinafter, cooperative networks) are presented. The cooperative network may include an explainer (or an explanation model), a reasoner (or a reasoning model), and a producer (or a production model). It may be a framework for discovering latent causes (or causal explanations) that satisfy causal relationships between observations and their labels and performing deterministic predictions based on the discovered causal relationships.

The explainer outputs a corresponding point in the explanatory space E based on a data point in the observation space X. The data distribution through the explainer can be represented as the conditional probability distribution P(E|X).

The reasoner outputs a data point in the label space Y, based on input points in the observation space X and in the explanatory space E. The data distribution through the reasoner can be represented as P(Y|X, E).

The producer outputs a data point in the observation space X, based on input points in the label space Y and in the explanatory space E. The data distribution through the producer can be represented as P(X|Y, E).

### 5. Prediction/Inference Mode

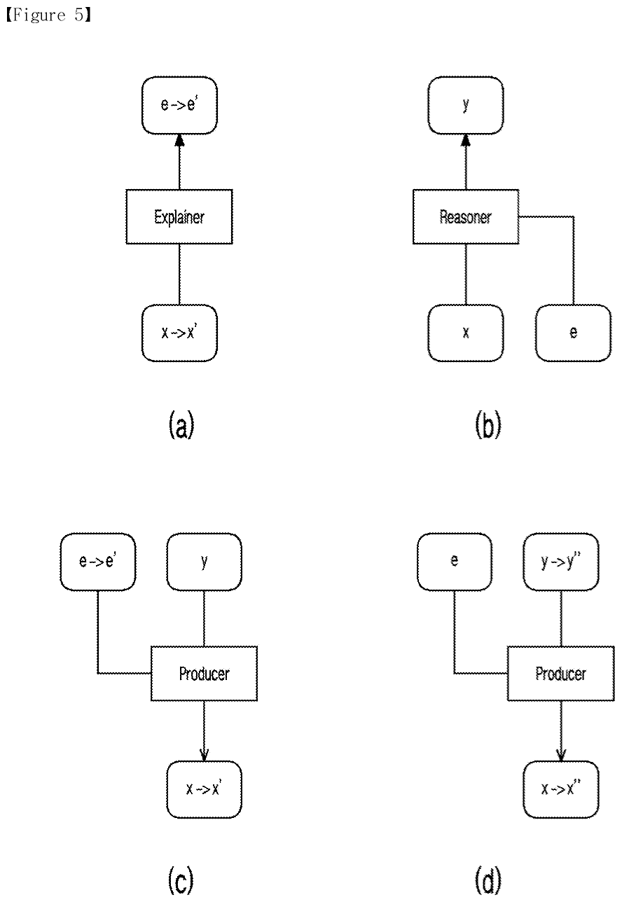

In FIG. 5, the prediction/inference mode for the trained explainer, reasoner, and producer of the cooperative networks are described. The prediction/inference mode of the models estimating a pose from an image of a certain/specific person observed in the field of robotics as an example will be described.

It is assumed that in the image (x) (observation) of a person in the observation space X, the pose (y) (label) of the person is specified. The identity (e) (causal explanation) of the observed person and the pose (y) (label) of the person are sufficient causes/conditions for the data generation of the image (x).

In FIG. 5A, the explainer predicts a causal explanation (an observed person's identity) from an observation input x (the observed person's image) and transmits a causal explanation vector e to the reasoner and the producer. The explainer can acquire a sample explanation vector e′ (any/specific person's identity) as the output from any/specific observation inputs. Alternatively, a sample explanation vector e′ may be acquired through random sampling in the learned explanatory space E representing identities of people.

In FIG. 5B, the reasoner infers the label (an observed pose) of the input observation for the observation input x and the received causal explanation vector e (the observed person's identity). A sample label y″ (random/specific pose) may be acquired as an output from any/specific observation and explanation vector inputs. Alternatively, a sample label y″ may be acquired through random sampling in the label space Y.

In FIG. 5C, the producer receives a label y (an observed pose) and a sample explanation vector e′ (any/specific person's identity) as inputs, and generates observational data x′ (any/specific person's image with the observed pose). The producer generates observational data x->x′ with a control e->e′ that receives a sample explanation vector instead of a causal explanation vector.

In FIG. 5D, the producer receives a sample label (random/specific pose) y″ and the causal explanation vector e (the observed person's identity) as inputs, and generate an observational data x″ (the observed person's image with a random/specific pose). The producer generates observational data x->x″ with a control y->y″ that receives a sample label instead of the label of the observed person.

In summary, any/specific causal explanation of an object can be obtained either from random sampling in the learned explanatory space or from the prediction output of the explainer. The reasoner reasons labels from observation inputs according to causal explanations. The producer produces causal effects that change under the control of the received label or causal explanation.

### 6. Training Mode

In the case of supervised learning, a neural network may learn to input an observation from a data set and predict a label for the input through error adjustment.

On the other hand, in the case of causal learning via causal cooperative networks, an observation (data/point) in a data set and a label are input as a pair and results in multiple outputs. A set of prediction losses of inference, generation, and reconstruction is calculated by the outputs and the input pair. Then, the explainer, the reasoner, and the producer are adjusted respectively by the backward propagation of errors obtained from the set of losses.

A prediction loss or a model error may be calculated in cooperative network training, using a function included in the scope of loss functions (or error functions) commonly used to calculate the prediction loss (or error) of a label output for an input in machine learning training. Calculating the loss or error based on the subtraction of B from A or the difference between A and B may also be included in the scope of the above function.

In cooperative network training, the prediction loss may refer to an inference loss, a generation loss, or a reconstruction loss. A prediction loss is obtained by two factors among the input (observation or label) and the multiple outputs that are passed as arguments to the parameters of the loss function. The loss function of the cooperative network with prediction parameter (parameter A) and target parameter (parameter B) may be defined as follows.

Prediction loss=loss function(parameter A,parameter B)

(In backpropagation, the path of parameter B may be detached from the backward path.)

As an example, in the cooperative network training (in training mode A, which will be described later), observation x and label y are inputs, and generated observation x1 and reconstructed observation x2 are outputs. Two factors among the observation x (input), the generated observation x1 (output), and the reconstructed observation x2 (output) are assigned to parameter A or parameter B, respectively. And an inference loss (x, y), a generation loss (x, y), and a reconstruction loss (x, y) for the input pair (x, y) are calculated.

Inference loss(x,y)=Loss function(reconstructed observations x2(output),generated observations x1(output))

Generation loss(x,y)=Loss function(generated observation x1(output),observation x(input))

Reconstruction loss(x,y)=Loss function(reconstructed observation x2(output),observation x(input))

As another example, in the cooperative network training (in training mode B, which will be described later), observation x and label y are inputs, and inferred label y1 and reconstructed label y2 are outputs. Two factors among the label y (input), the inferred label y1 (output), and the reconstructed label y2 (output) are assigned to parameter A or parameter B, respectively. Also an inference loss (x, y), a generation loss (x, y), and a reconstruction loss (x, y) for the input pair (x, y) are calculated.

Inference loss(x,y)=Loss function(inferred label y1(output),label y(input))

Generation loss(x,y)=Loss function(reconstructed label y2(output),inferred label y1(output))

Reconstruction loss(x,y)=Loss function(reconstructed label y2(output),label y(input))

In the cooperative network training, a model error may refer to the explainer errors, the reasoner errors, or the producer errors. The model error may be obtained from a set of prediction losses delivered to the error function. That is, the inference loss, generation loss, and reconstruction loss are assigned to either prediction loss A, prediction loss B, or prediction loss C, which are parameters of the error function and the corresponding model error is obtained. Prediction loss A and prediction loss B correspond to the prediction parameters, and prediction loss C corresponds to the target parameter of the error function.

Model error=Error function(prediction loss A+prediction loss B,prediction loss C)

(In backpropagation, the path of prediction loss C may be detached from the backward paths.)

As shown in the example below, the model error is obtained from the prediction loss located in the parameters of the error function.

Explainer error(x,y)=Error function(inference loss(x,y)+generation loss(x,y),reconstruction loss(x,y))

Reasoner error(x,y)=Error function(reconstruction loss(x,y)+inference loss(x,y),generation loss(x,y))

Producer error(x,y)=Error function(generation loss(x,y)+reconstruction loss(x,y),inference loss(x,y))

The gradients of the error function with respect to the parameters (weights or biases) of neural networks are calculated by the backpropagation of the explainer, reasoner, or producer errors respectively. Also the parameters are adjusted through model updates for the retained gradients. The error traverses backward through the propagation path (or the automatic differential calculation graph) created by the prediction losses included in the error function.

### 7. Prediction Loss

During training, the cooperative network uses an observation and a label thereof as an input and calculates an inference loss, generation loss, or reconstruction loss from multiple outputs for the input. A prediction loss refers to an inference loss, a generation loss, or a reconstruction loss.

First, the inference loss is the loss that occurs when inferring labels from inputted/received observations. The inference of the label from the observations involves the computation of the explainer and reasoner. The inference loss may include errors that occur while calculating along the signal path through the explainer and reasoner.

Second, the generation loss is the loss that occurs when generating observations from inputted/received labels. The generation of the observation from the labels involves the computation of the explainer and producer. The generation loss may include errors that occur while calculating along the signal path through the explainer and producer.

Third, the reconstruction loss is the loss that occurs when reconstructing observations or labels. The reconstruction of observations or labels involves the computation of the reasoner and producer. The reconstruction loss may include errors that occur while calculating along the signal path through the reasoner and producer.

Cooperative networks have two training modes. They are distinguished by how a prediction loss is calculated. Model errors can be obtained from the set of prediction losses via either the training mode A (explicit causal learning) or the training mode B (implicit causal learning).

### 8. Prediction Loss-Training Mode A

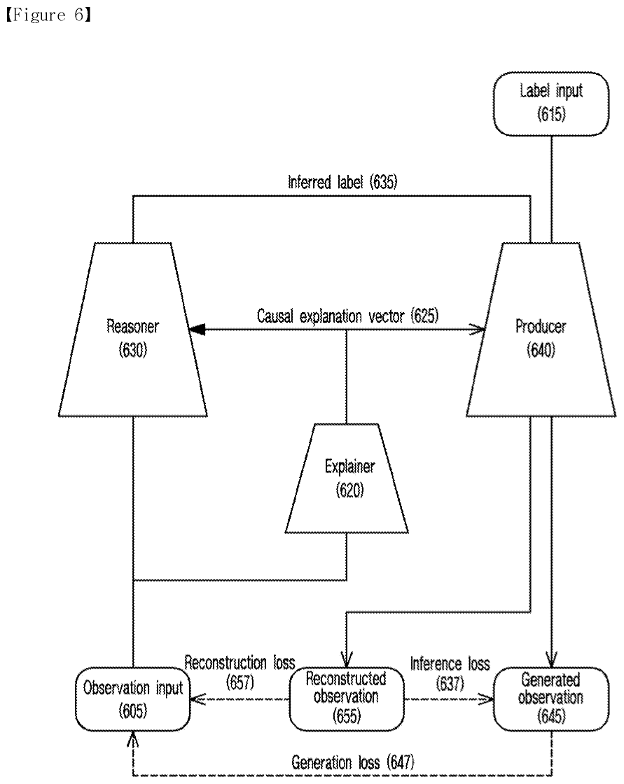

In FIG. 6, in training mode A, the cooperative network inputs an observation 605 and a label 615, and outputs a generated observation 645 and a reconstructed observation 655. The explainer 620 and the reasoner 630 of the cooperative network receive the observation 605 as an input, and the producer 640 receives the label 615 as an input.

The explainer 620 transmits to the reasoner 630 and the producer 640 a causal explanation vector 625 in an explanatory space for the input observation 605.

The reasoner 630 infers a label from the input observation 605 and the received explanation vector 625 and transmits the inferred label 635 to the producer.

The producer 640 generates an observation based on the input label 615 and the received explanation vector 625 and outputs the generated observation 645.

The producer 640 reconstructs the input observation from the received explanation vector 625 and the inferred label 635 and outputs the reconstructed observation 655.

Referring to FIGS. 6 to 9, in training mode A, a set of prediction losses, which are an inference loss, a generation loss, and a reconstruction loss, is obtained from the observation 605, the generated observation 645, or the reconstructed observation 655.

Inference loss=Loss function(reconstructed observation,generated observation)

Generation loss=Loss function(generated observation,input observation)

Reconstruction loss=Loss function(reconstructed observation,input observation)

The prediction losses in training mode A will be described in detail.

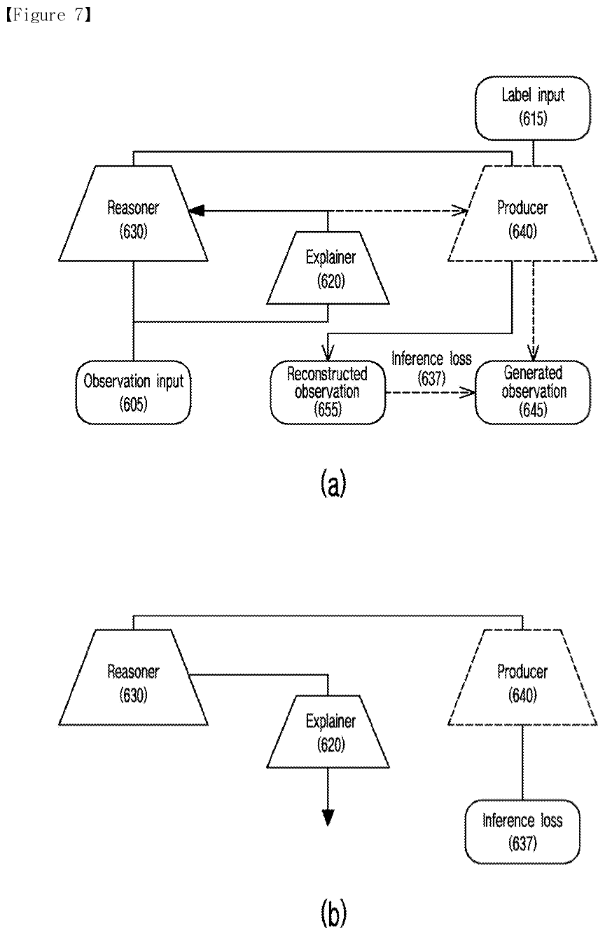

In FIG. 7A, the inference loss 637 is the prediction loss from the reconstructed observation 655 to the generated observation 645. From the observation 605 and the label input 615 input to the cooperative net, the loss may correspond to the error occurring during calculations in the path, which is corresponding to the difference in the propagation path created from the reconstructed observation output 655 to the generated observation output 645.

In FIG. 7B, error backpropagation through the path of inference loss 637 passes through the producer 640, and thus the gradients of the error function with respect to the parameters of the reasoner 630 or the explainer 620 is computed. The backpropagation of the explainer error through inference loss calculates the gradients of the error function with respect to the parameters of the explainer without being involved in adjusting the reasoner or the producer. The backpropagation of the reasoner error through inference loss calculates the gradients of the error function with respect to the parameter of the reasoner without being involved in adjusting the producer or the explainer.

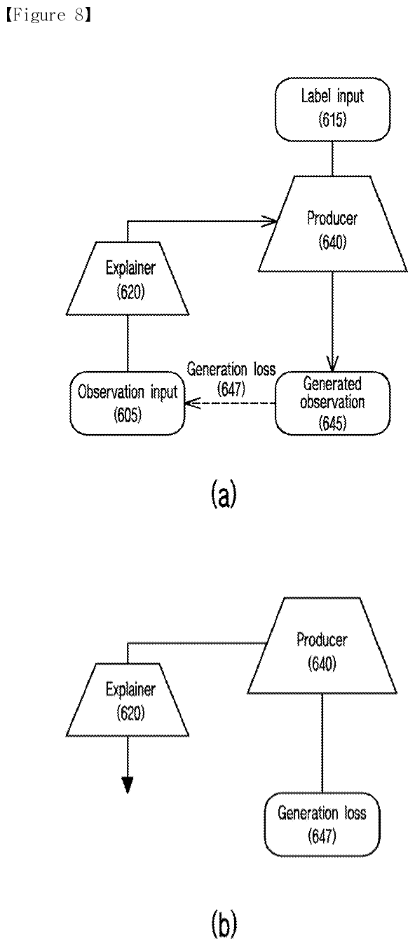

In FIG. 8A, the generation loss 647 is the prediction loss from the generated observation output 645 to the observation input 605. It may correspond to the error occurring during calculations in the path from the input of observation 605 and label 615 to the output of generated observation 645.

In FIG. 8B, error backpropagation through the generation loss 647 calculates the gradients with respect to the parameters of the producer 640 or the explainer 620. The backpropagation of the explainer error through the generation loss calculates the gradient of the error function for the parameter of the explainer without being involved in adjusting the reasoner or the producer. The backpropagation of the producer error through the generation loss calculates the gradient of the error function for the parameter of the producer without being involved in adjusting the explainer or the reasoner.

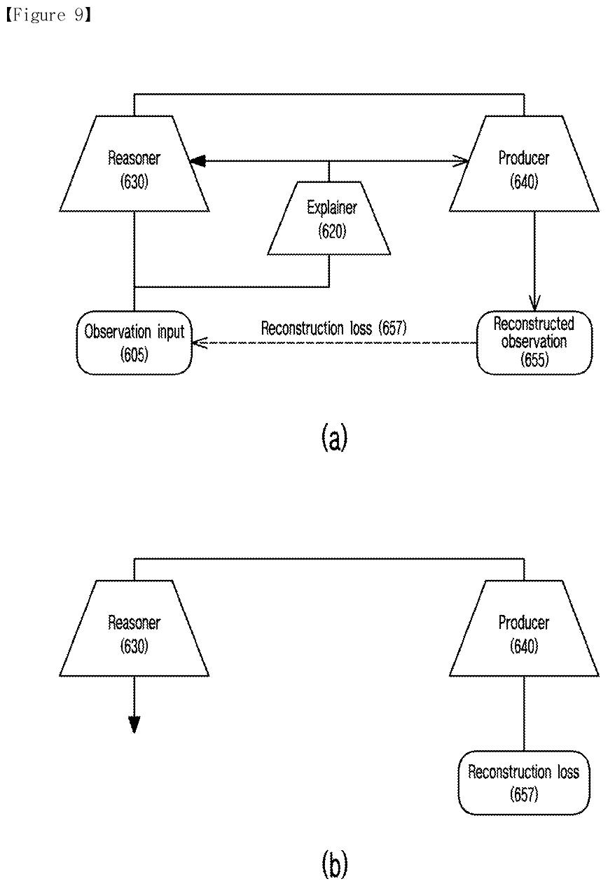

In FIG. 9A, the reconstruction loss 657 is the prediction loss from the reconstructed observation output 655 to the observation input 605. The forward path from the observation input 605 to the reconstructed observation output 655 may include calculations involving the explainer 620, the reasoner 630, or the producer 640.

In FIG. 9B, error backpropagation through the reconstruction loss 657 calculates the gradients with respect to the parameter of the reasoner 630 or the producer 640, and the explainer 620 may be excluded (or the output signal of the explainer may be detached). The backpropagation of the reasoner error through the reconstruction loss calculates the gradient of the error function for the parameter of the reasoner without being involved in adjusting the explainer or the producer. The backpropagation of producer error through reconstruction loss calculates the gradient of the error function for the parameter of the producer without being involved in adjusting the explainer or the reasoner.

### 9. Loss of Prediction-Training Mode B

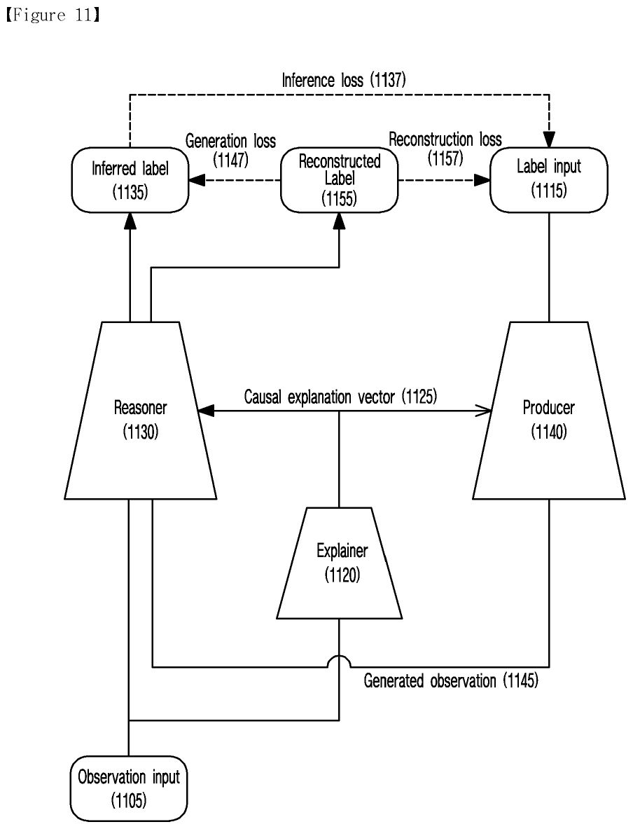

Referring to FIG. 11, in training mode B, the observation 1105 and the label 1115 are used as inputs, and the inferred label 1135 and a reconstructed label 1155 are output from the cooperative network training. The explainer 1120 and a reasoner 1130 in the cooperative network receive the observation 1105 as an input, and the producer 1140 receives the label 1115 as an input.

The explainer 1120 transmits, to the reasoner 1130 and the producer 1140, a causal explanation vector 1125 in an explanatory space for the input observation 1105.

The producer 1140 generates an observation based on the received explanation vector 1125 and the input label 1115, and transmits the generated observation 1145 to the reasoner.

The reasoner 1130 infers a label from the received explanation vector 1125 and the input observation 1105 and outputs the inferred label 1135.

The reasoner 1130 reconstructs the input label based on the received explanation vector 1125 and the generated observation 1145 and outputs the reconstructed label 1155.

Referring to FIGS. 11 to 14, prediction losses may be obtained from the input label, the inferred label, and the reconstructed label in training mode B.

Inference loss=Loss function(inferred label,input label)

Generation loss=Loss function(reconstructed labels,inferred labels)

Reconstruction loss=Loss function(reconstructed label,input label)

The prediction losses in training mode B will be described in detail.

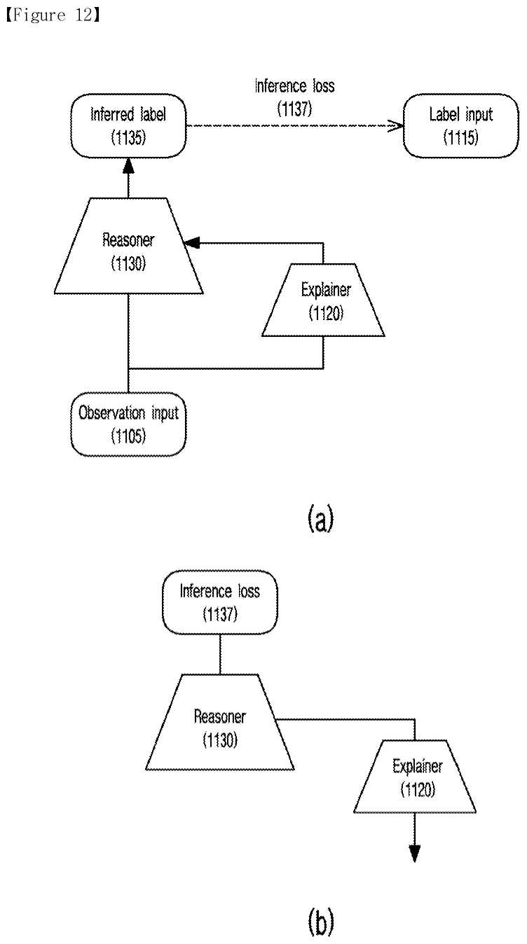

In FIG. 12A, the inference loss 1137 is the prediction loss from the inferred label output 1135 to the label input 1115. It may correspond to the error occurring during calculations in the path from the observation input 1105 to the inferred label output 1135.

In FIG. 12B, error backpropagation through the path of the inference loss 1137 calculates the gradient of the error function with respect to the parameters of the reasoner 1130 or the explainer 1120. The backpropagation of the explainer error through the inference loss calculates the gradient of the error function for the parameter of the explainer without being involved in adjusting the reasoner or the producer. The backpropagation of the reasoner error through the inference loss calculates the gradient of the error function for the parameter of the reasoner without being involved in adjusting the explainer or the producer.

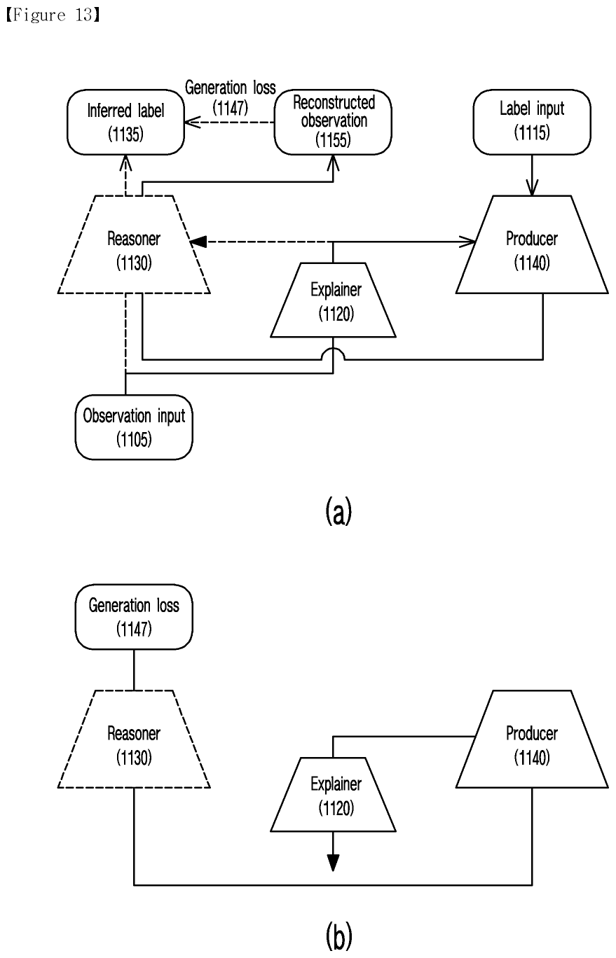

In FIG. 13A, the generation loss 1147 is the prediction loss from the reconstructed label 1155 to the inferred label 1135. From the observation 1105 and the label input 1115 input, the loss may correspond to the error occurring during calculations in the path corresponding to the difference in the propagation path, which is created from the reconstructed label output 1155 to the inferred label output 1135.

In FIG. 13B, error backpropagation through the path of the generation loss 1147 passes through the reasoner 1130, and thus the gradient with respect to the parameters of the producer 1140, or the explainer 1120 is calculated. The backpropagation of the explainer error through the generation loss calculates the gradient of the error function for the parameters of the explainer without being involved in adjusting the reasoner or the producer. The backpropagation of the producer error through generation loss calculates the gradient of the error function for the parameter of the producer without being involved in adjusting the explainer or the reasoner.

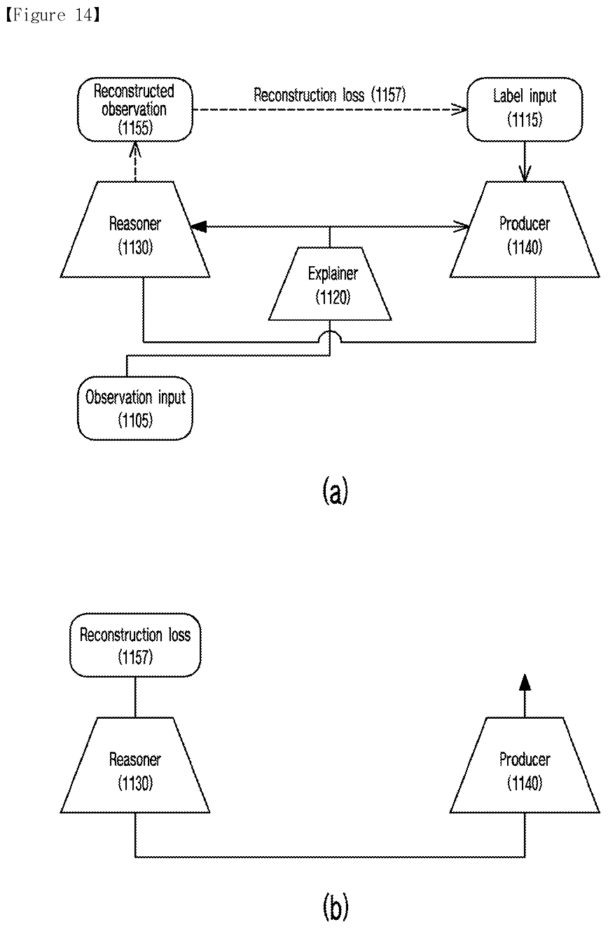

In FIG. 14A, the reconstruction loss 1157 is the prediction loss from the reconstructed label output 1155 to the label input 1115. The forward path from the input of the observation 1105 and label 1115 to the output of the reconstructed label 1155 may include calculations involving the explainer 1120, the reasoner 1130, or the producer 1140.

In FIG. 14B, error backpropagation through the reconstruction loss 1157, calculates the gradient with the respect to the parameter of the reasoner 1130 and the producer 1140, and the explainer 1120 may be excluded (or the output signal of the explainer may be detached). The backpropagation of the producer error through the reconstruction loss calculates the gradient of the error function for the parameter of the producer without being involved in adjusting the explainer or the reasoner. The backpropagation of the reasoner error through the reconstruction loss calculates the gradient of the error function for the parameter of the reasoner without being involved in adjusting the explainer or the producer.

In the descriptions related to training mode A/B above, the inputs and outputs of cooperative networks such as observations, labels, causal explanations, generated observations, reconstructed observations, inferred labels, and reconstructed labels may have data types such as points, images, values, arrays, vectors, codes, representations, points, vectors/latent representations in n-dimensional/latent space, among others.

### 10. Model Error

In the training of cooperative networks, a model error may refer to an explainer, reasoner, or producer error. A model error may be obtained from error functions with a set of prediction losses. That is, a set of prediction losses is calculated to obtain model errors, and each model error is obtained from the prediction losses combined in error functions.

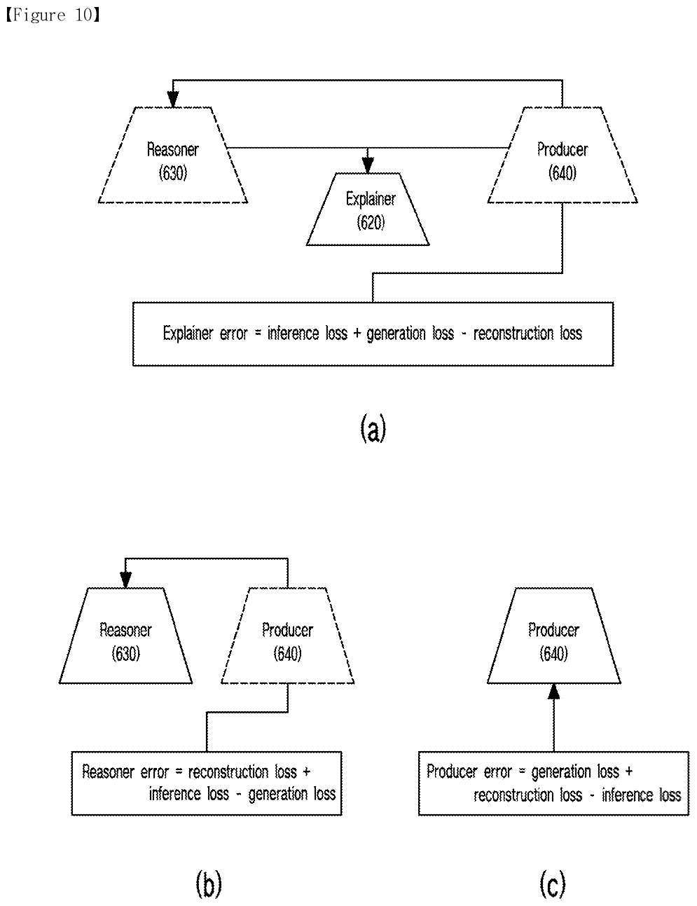

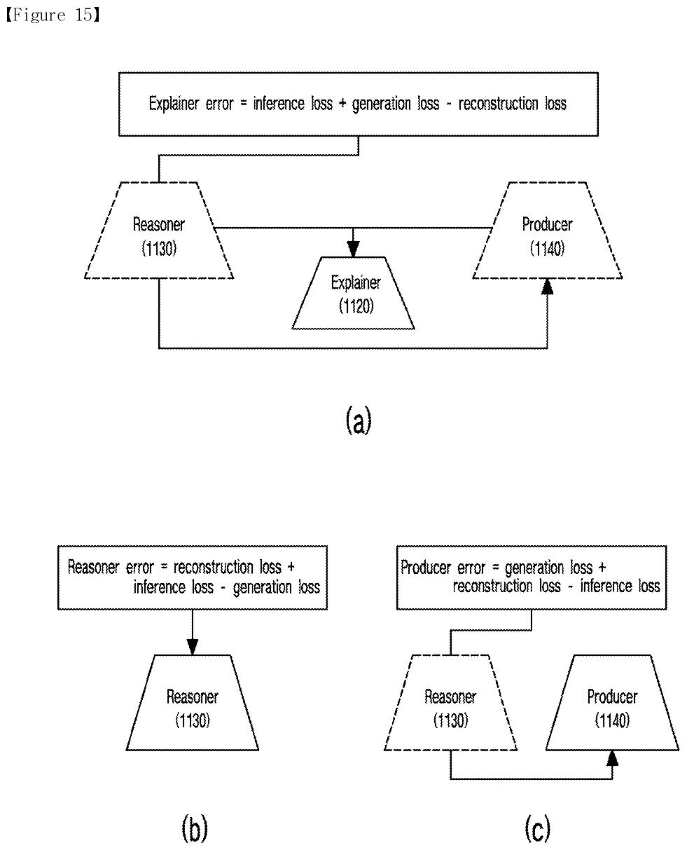

Referring to FIG. 10 (training mode A) and FIG. 15 (training mode B), a model error may be obtained from the prediction losses.

Explainer error=Error function (inference loss+generation loss,reconstruction loss)

Reasoner error=Error function (reconstruction loss+inference loss,generation loss)

Producer error=Error function (generation loss+reconstruction loss,inference loss)

The explainer error is the error that occurs in the prediction of a causal explanation from observations. The explainer error may be obtained from the prediction (or difference or subtraction) of the reconstruction loss from the sum of the generation loss and the inference loss.

The reasoner error is the error that occurs in the reasoning (or inferring) of a label from observations with a given causal explanation. The reasoner error may be obtained from the prediction (or difference/subtraction) of the generation loss from the sum of the reconstruction loss and the inference loss.

The producer error is the error that occurs in the production (or generation) of observations from labels with a given causal explanation. The producer error may be obtained from the prediction (or difference/subtraction) of the inference loss from the sum of the generation loss and the reconstruction loss.

The backpropagation of the explainer, reasoner, or producer errors may adjust the parameters (weights or biases) of the corresponding model. The gradients of the error function with respect to the parameters of the neural network are calculated through the backpropagation. The error may be adjusted through a model update based on accumulated gradients with respect to parameters of the model. The error backpropagation may pass through paths created by forward passes of prediction losses.

The backward propagation of model errors can be modified from paths created by forward passes. Some propagation paths for prediction losses may be detached from the backward paths, which are the losses delivered to the target parameter of the loss function (or error function). For example, the error that occurs going backwards through the forward path for the prediction losses when the losses are delivered to the prediction parameter of loss/error functions. On the other hand, when the prediction losses are delivered to the target parameter of loss/error functions the backward paths from the losses may be detached. Error backpropagations through detached paths may not happen.

Error backward propagation may pass neural networks that are not the target of adjustment by freezing the parameter of the neural networks located on the way to the target, and the gradient of the target neural network can be computed.

Alternatively, for neural networks that are not subject to adjustment, the neural networks may be included in the path of both the prediction parameter and the target parameter of the loss function (or error function). Thereby, the parameters of the neural networks included in the common path may receive an equal effect equal to the freezing of the parameters in the backpropagation.

Hereinafter, the backpropagation of model errors in the training mode A will be described. In FIG. 10A, the backpropagation of the explainer error calculates the gradients of the explainer 620, by passing the parameters of the producer 640 and the reasoner 630 without being involved in adjustment. In FIG. 10B, the backpropagation of the reasoner error calculates the gradients of the reasoner 630, by passing the parameters of the producer 640 without being involved in adjustment. In FIG. 10C, the backpropagation of the producer error calculates the gradients of the producer 640.

To prevent unwanted parameter adjustment from error backpropagation for neural networks on peripheral paths, the paths can be detached from the propagation paths. For example, in FIG. 10A, the gradients for the explainer 620 may be calculated through the backpropagation of the explainer error. Then the output signal of the explainer 620 may be detached from the propagation path to prevent further adjustment from error backpropagation for the reasoner 630 or the producer 640. In FIG. 10B, the gradients for the reasoner 620 may be calculated by the backpropagation of the reasoner error. Then the output signal of the reasoner 620 may be detached from the propagation path to prevent adjustment from error backpropagation for the producer 640.

Hereinafter, the backpropagation of model errors in the training mode B will be described. In FIG. 15A, the backpropagation of the explainer error calculates the gradients of the explainer 1120, by passing the parameters of the reasoner 1130 and the producer 1140 without being involved in adjustment. In FIG. 15C, the backpropagation of the producer error calculates the gradients of the producer 1140, by passing the parameters of the reasoner 1130 without being involved in adjustment. In FIG. 15B, the backpropagation of the reasoner error calculates the gradients of the reasoner 1130.

To prevent unwanted parameter adjustment from error backpropagation for neural networks on peripheral paths, the paths can be detached from the propagation paths. For example, in FIG. 15A, the gradients for the explainer 1120 may be calculated through the backpropagation of the explainer error. Then the output signal of the explainer 1120 may be detached from the propagation path to prevent further adjustment from error backpropagation for the producer 1140 or the reasoner 1130. In FIG. 15C, the gradients for the producer 1140 may be calculated by the backpropagation of the producer error. Then the output signal of the producer 1140 may be detached from the propagation path to prevent adjustment from error backpropagation for the reasoner 1130.

The gradients of the explainer, reasoner, and producer error may be calculated through the backpropagation of the model error. The model errors such as explainer error, reasoner error, and producer error or the prediction losses such as inference loss, generation loss, and reconstruction loss may gradually decrease or converge to a certain value (e.g., 0) through a model update during training.

### 11. Training Using a Pretrained Model

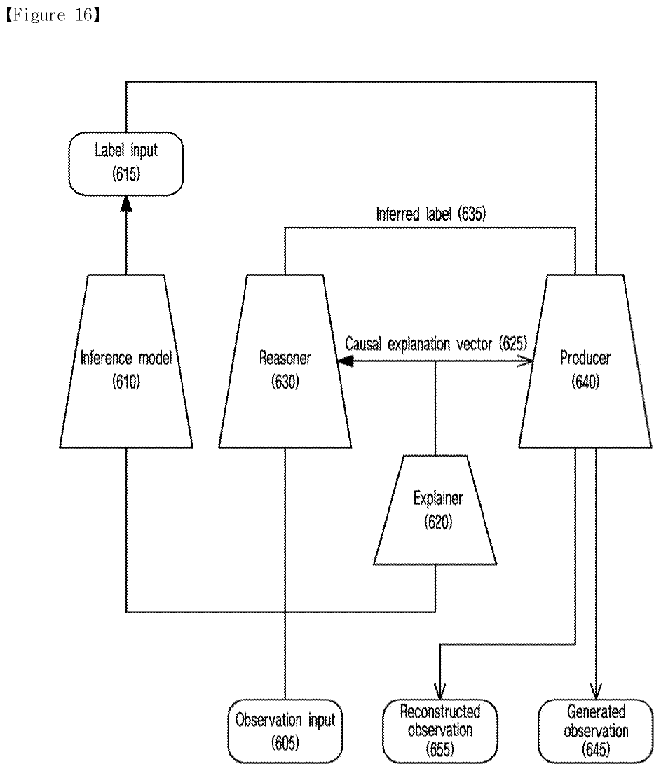

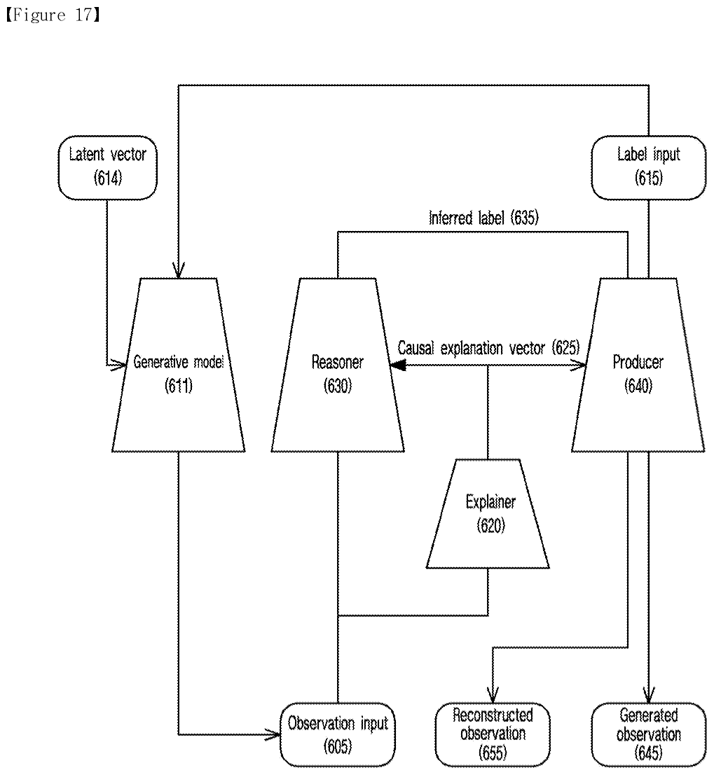

Hereinafter, learning a causal relationship from the inputs and outputs that are mapped through a pretrained model (or a model being trained) will be described with reference to FIGS. 16 and 17. The pretrained model may refer to a neural network model in which the input space and the output space are statistically mapped. The pretrained model may refer to a model that results in outputs for an input through a stochastic process. A causal cooperative network may be configured by adding a pretrained model. The causal relationship between the input space and the output space of the pretrained model can be discovered by cooperative network training. Output of a pretrained inference model 610 in FIG. 16 may correspond to a label input 615, and the output of a pretrained generative model 611 in FIG. 17 may correspond to an observation input 605.

FIG. 16 shows an example of cooperative network training with the pretrained inference model 610. The input space and the output space of the pretrained model may be understood with reference to the description related to the inference model of FIG. 2A. The cooperative network training additionally includes the inference model 610 in the configuration of FIG. 6. The output of the inference model for the observation input 605 can correspond to the label input 615.

FIG. 17 shows an example of a cooperative network training with the pre-trained generative model 611. The input space and the output space of the pretrained model may be understood with reference to the description related to the generative model of FIG. 2B. The cooperative network is configured by additionally including the generative model 611 in the configuration of FIG. 6. The output of the generative model corresponds to the observation input 605 from the input label (condition input) 615 and the latent vector 614.

In summary, the reverse or bidirectional inference of the pretrained model is learned by causal learning through the cooperative network training. For example, the producer and the explainer may train the reverse direction of inference from the trained inference models. Alternatively, the reasoner and the explainer may train the opposite direction of inference from the pretrained generative models. Causal learning from pretrained models through cooperative networks may be applied in fields where reverse or bidirectional inference is difficult to learn.

### 12. Applied Embodiment

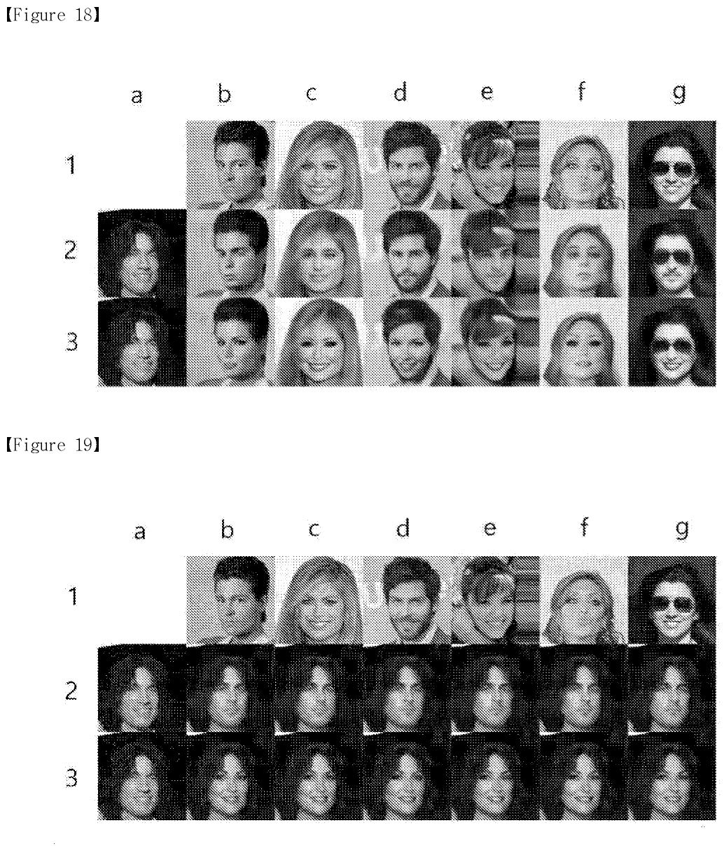

FIGS. 18 and 19 assume an example of causal learning using the Celeb A dataset, which contains hundreds of thousands of images of real human faces. Explicit features of the face, such as gender and smile, are binary-labeled on each image.

The labels ‘gender’ and ‘smile’ may have real values between 0 and 1. In the dataset for gender, women are labeled with 0 and men with 1. For smile, a non-smiling expression is labeled with 0, and a smiling expression with 1.

A cooperative network composed of an explainer, a reasoner, and a producer learns a causal relationship between observations (face image) and the labels (gender and smile) of the observations in the dataset through either training mode A or training mode B. In this embodiment, it is shown that trained models of the cooperative network create images of a new human face based on real human face images.

The explainer may include a convolutional neural network (CNN), and receives an image and transmits an explanation vector in a low-dimensional space (e.g., 256 dimensions) to the reasoner and producer. Explanation vectors in the explanatory space represent facial attributes independent of labeled attributes such as gender or smile.

The reasoner including a CNN infers labels (gender and smile), and outputs inferred labels from the image with an explanation vector as input.

The producer including a transpose CNN generates an observational data(image), and outputs the generated observation from the labels with an explanation vector as input.

Referring to FIGS. 18 and 19, in the row (1) and columns (b˜g) show 6 different real images in the data set. In the rows (2˜3) and column (a) shows two identical real images contained in the data set. The generated images by the producer from the input of labels and explanation vectors are shown in the rows (2˜3) and columns (b˜g).

More specifically, the producer's outputs for the input labels (gender 1), and smile (0): a man who is not smiling) are shown in the row (2) and columns (b˜g). The producer's outputs for the input labels (gender (0), and smile (1): a smiling women) are shown in the row (3) and columns (b˜g).

In FIG. 18, the explainer inputs six different real images in the row (1) and columns (b˜g), extracts an explanation vector for each image, and transmits the vectors to the producer. The producer receives the explanation vectors for the six real images, outputs the generated images from the input labels (gender (1) and smile (0)) to the row (2) and columns (b˜g), and outputs the generated images from the input labels (gender (0) and smile (1)) to the row (3) and columns (b˜g).

In FIG. 19, the explainer inputs the same real image, and extracts an explanation vector for the image in the rows (2˜3) and column (a), and transmits the vector to the producer. The producer receives the explanation vector for the same image, outputs the generated images from the input labels (gender (1), and smile (0)) to the row (2) and columns (b˜g), and outputs the generated images from the input labels (gender (0) and smile (1)) to the row (3) and columns (b˜g).

The framework for causal learning of the neural network discussed above may be applied to various fields as well as the present embodiment of creating images of human faces.

What is claimed is:

1. A method for causal learning of neural networks, implemented by a controller, comprising:
a cooperative network configured to receive an observation in a source domain and a label for the observation in a target domain, and learn a causal relationship between the source domain and the target domain through models of an explainer, a reasoner, and a producer, each including a neural network, wherein:
the explainer extracts, from an input observation, an explanation vector representing an explanation of the observation and transmits the vector to the reasoner and the producer;
the reasoner infers a label from the input observation and the received explanation vector and transmits the inferred label to the producer; and
the producer outputs an observation reconstructed from the received inferred label and the explanation vector, and outputs an observation generated from an input label and the explanation vector,
wherein the errors are obtained from an inference loss, a generation loss and a reconstruction loss calculated by the input observation, the generated observation, and reconstructed observation; and
wherein the inference loss is a loss from the reconstructed observation to the generated observation and includes an explainer error and/or a reasoner error, the generation loss is a loss from the generated observation to the input observation and includes an explainer error and/or a producer error, and the reconstruction loss is a loss from the reconstructed observation to the input observation and includes a reasoner error and/or a producer error, the explainer error is obtained based on a difference of the reconstruction loss from a sum of the inference loss and the generation loss, the reasoner error is obtained based on a difference of the generation loss from a sum of the reconstruction loss and the inference loss, and the producer error is obtained based on a difference of the inference loss from a sum of the generation loss and the reconstruction loss.

2. The method of claim 1, wherein gradients of the error functions with respect to parameters of the models are calculated through backpropagation of the explainer error, the reasoner error, and the producer error.

3. The method of claim 2, wherein the parameters of the models are adjusted based on the calculated gradients.

4. The method of claim 3, wherein:
the backpropagation of the explainer error calculates gradients of the error function with respect to the parameters of the explainer without being involved in adjusting the reasoner or the producer;
the backpropagation of the reasoner error calculates gradients of the error function with respect to the parameters of the reasoner without being involved in adjusting the producer; and
the backpropagation of the producer error calculates gradients of the error function with respect to the parameters of the producer.

5. The method of claim 1, wherein the cooperative network includes a pretrained model that is pretrained or being trained, and an input space mapped to an output space via the pretrained model,
wherein the neural network models are trained with causal inference by discovering a causal relationship between the input space and the output space of the pretrained model,
wherein the pretrained model comprises:
an inference model configured to receive the observation as input and maps an output to the input label.

6. The method of claim 1, wherein the cooperative network includes a pretrained model that is pretrained or being trained, and an input space mapped to an output space via the pretrained model,
wherein the neural network models are trained with causal inference by discovering a causal relationship between the input space and the output space of the pretrained model,
wherein the pretrained model comprises:
a generative model configured to receive the label and a latent vector as input and maps an output to the input observation.

7. A method for causal learning of a neural network, comprising:
a cooperative network configured to receive an observation in a source domain and a label for the observation in a target domain, and learn a causal relationship between the source domain and the target domain through models of an explainer, a reasoner, and a producer, each including a neural network,
wherein:
the explainer extracts, from an input observation, an explanation vector representing an explanation of the observation for a label and transmits the vector to the reasoner and the producer;
the producer outputs an observation generated from a label input and the explanation vector, and transmits the generated observation to the reasoner; and
the reasoner outputs a label reconstructed from the generated observation and the explanation vector, and infers a label from the input observation and the explanation vector to output the inferred label,
wherein the errors of models are obtained from an inference loss, a generation loss and a reconstruction loss calculated by the input label, the inferred label, and the reconstructed label; and
wherein the inference loss is a loss from the inferred label to the label input, the generation loss is a loss from the reconstructed label to the inferred label, and the reconstruction loss is a loss from the reconstructed label to the label input, the inference loss includes an explainer error and a reasoner error, the generation loss includes an explainer error and a producer error, and the reconstruction loss includes a reasoner error and a producer error, the explainer error is obtained based on a difference of the reconstruction loss from a sum of the inference loss and the generation loss, the reasoner error is obtained based on a difference of the generation loss from a sum of the reconstruction loss and the inference loss, the producer error is obtained based on a difference of the inference loss between from a sum of the generation loss and the reconstruction loss, and wherein gradients of the error functions for parameters of the models are calculated through backpropagation of the explainer error, the reasoner error, and the producer error.

8. The method of claim 7, wherein the parameters of the neural networks are adjusted based on the calculated gradients.

9. The method of claim 7, wherein:
the backpropagation of the explainer error calculates gradients of the error function with respect to the parameters of the explainer without being involved in adjusting the reasoner or the producer;
the backpropagation of the producer error calculates gradients of the error function with respect to the parameters of the producer without being involved in adjusting the reasoner; and
the backpropagation of the reasoner error calculates gradients of the error function with respect to the parameter of the reasoner.

10. The method of claim 7, wherein the cooperative network includes a pretrained model that is pretrained or being trained, and an input space mapped to an output space via the pretrained model,
wherein the neural network models are trained with causal inference by discovering a causal relationship between the input space and the output space of the pretrained model,
wherein the pretrained model comprises:
an inference model configured to receive the observation as input and map an output to the input label.

11. The method of claim 7, wherein the cooperative network includes a pretrained model that is pretrained or being trained, and an input space mapped to an output space via the pretrained model,
wherein the neural network models are trained with causal inference by discovering a causal relationship between the input space and the output space of the pretrained model,
wherein the pretrained model comprises:
a generative model configured to receive the label and a latent vector as input and maps an output to the input observation.
